(19) United States
(12) Patent Application Publication
(10) Pub. No.: US 2017/0331931 A1
(43) Pub. Date: Nov. 16, 2017

(54) APPLICATION LAYER HEADER OR PAYLOAD ENRICHMENT WITHOUT PROXY OR CONNECTION TERMINATION

(71) Applicant: NOKIA SOLUTIONS AND NETWORKS OY, Espoo (FI)

(72) Inventor: Peter SZILAGYI, Budapest (HU)

(21) Appl. No.: 15/527,514

(22) PCT Filed: Nov. 17, 2014
(86) PCT No.: PCT/EP2014/074766

§ 371 Date: May 17, 2017

(51) Int. Cl. H04L 29/08; H04W 12/06

(52) U.S. Cl. CPC H04L 69/329; H04W 12/06; H04L 29/08; H04L 67/2804

(57) ABSTRACT

Various communication systems may benefit from header or payload data enrichment. For example, certain mobile communication systems may benefit from application layer header or data enrichment without proxy or connection termination. A method includes determining at a sending side that application layer enrichment is to be performed on an application layer stream (310). The method includes inserting, by a communicating application, placeholder bytes into the stream, wherein the placeholder bytes are configured to be overwritten for the application layer enrichment (320). At a proxy device, the placeholder bytes are overwritten (340). At the receiving side, the overwritten placeholder bytes are read (360). The placeholder bytes may be overwritten with information on network conditions, for example cell load or throughput.

### BACKGROUND

### Field

Various communication systems may benefit from header or data enrichment. For example, certain mobile communication systems may benefit from application layer header or data enrichment without proxy or connection termination.

### Description of the Related Art

Protocol header enrichment is a mechanism to piggyback information on packets by a middle box: for example, to provide locally available contextual information to the communicating end points. In mobile systems such as long term evolution (LTE), the enrichment may be implemented in radio access nodes, such as the evolved Node B (eNB), radio application cloud server (RAGS) or radio network controller (RNC) to expose radio context information. The communicating endpoints may be the user equipment (UE) and the content server, as well as a content delivery network (CDN) node or an intermediate optimization gateway or proxy.

Transmission control protocol (TCP) header enrichment can provide, for example, Throughput Guidance information to the content servers for TCP and media optimization. This mechanism may utilize the TCP Option field to extend the header with additional information bytes. When the TCP Option field is extended, the additional information can be conveyed in the TCP header, which is not covered by the TCP sequence numbering. Therefore, additional bytes can be inserted to the in-band TCP data stream in a lightweight manner, without invalidating the sequence numbers and requiring a TCP proxy.

In certain deployments, the TCP Option headers may not enable end-to-end information delivery due to intermediate devices, such as firewalls, that may strip off the extra information or, alternatively, discard the enriched packets as such. A possible way to address this is to enrich information into the application layer protocols, such as into HTTP. As the application layer is not interpreted by routers or firewalls, information enriched to the application layer may be delivered end-to-end even when TCP header enrichment would not work. With application layer enrichment there may be the possibility of getting and interpreting the enriched data in the user space by the receiver application, without a need for modifying the TCP stack in the kernel to obtain data from the TCP header.

Many applications transmit data over TCP. Thus, the enrichment of the application layer may need to be compatible with TCP. The application layer header or data may be considered as payload from the TCP point of view and may be in the scope of TCP sequence numbering. In case additional bytes were enriched into the application layer without adjusting the TCP sequence numbers, the enriched packet would become invalid and break the connection on the TCP level. For that reason, application layer content manipulation may be implemented by a proxy, such as an HTTP proxy.

Proxies can terminate the TCP connection towards both original endpoints, for example the UE and the content server, and become TCP endpoints themselves. Such an approach can be referred to as a split connection TCP proxy. However, when such proxy is implemented in a radio access node such as a RAGS, eNB, or RNC, it may break the connections during handover. Therefore, a proxy based application layer enrichment may not be applicable in case the enrichment is implemented in the radio access.

In case an application uses TCP to transfer data, in-band application layer enrichment by a middle box may be challenging because any additional application level bytes increase the length of the TCP payload. This increased length conventionally invalidates the TCP sequence numbers and creates an invalid packet that would be discarded by the receiving TCP endpoint. One possibility to overcome this issue is to deploy a proxy that splits the end-to-end TCP connection and enables flexible application level content modification. However, in certain deployments, such as in the LTE eNB, RAGS or RNC, the use of such a proxy may introduce proxy failure during handover.

### SUMMARY

According to certain embodiments, a method can include determining that application layer enrichment is to be performed on an application layer stream. The method can also include inserting, by a communicating application, placeholder bytes into the stream, wherein the placeholder bytes are configured to be overwritten for the application layer enrichment.

In certain embodiments, a method can include determining that application layer enrichment is to be performed on an application layer stream. The method can also include overwriting placeholder bytes inserted into the stream by a communicating application endpoint for the application layer enrichment.

A method, according to certain embodiments, can include determining that application layer enrichment has been performed on an application layer stream. The method can also include reading overwritten bytes, wherein the overwritten bytes were inserted by a middle box for the application layer enrichment into the stream transmitted by a communicating application endpoint.

An apparatus, in certain embodiments, can include means for determining that application layer enrichment is to be performed on an application layer stream. The apparatus can also include means for inserting, by a communicating application, placeholder bytes into the stream, wherein the placeholder bytes are configured to be overwritten for the application layer enrichment.

According to certain embodiments, an apparatus can include means for determining that application layer enrichment is to be performed on an application layer stream. The apparatus can also include means for overwriting placeholder bytes inserted into the stream by a communicating application endpoint for the application layer enrichment.

In certain embodiments, an apparatus can include means for determining that application layer enrichment has been performed on an application layer stream. The apparatus can include means for reading overwritten bytes, wherein the overwritten bytes were inserted by a middle box for the application layer enrichment into the stream transmitted by a communicating application endpoint.

An apparatus, according to certain embodiments, can include at least one processor and at least one memory including computer program code. The at least one memory and the computer program code can be configured to, with the at least one processor, cause the apparatus at least to determine that application layer enrichment is to be performed on an application layer stream. The at least one memory and the computer program code can also be configured to, with the at least one processor, cause the apparatus at least to insert, by a communicating application, placeholder bytes into the stream, wherein the placeholder bytes are configured to be overwritten for the application layer enrichment.

An apparatus, in certain embodiments, can include at least one processor and at least one memory including computer program code. The at least one memory and the computer program code can be configured to, with the at least one processor, cause the apparatus at least to determine that application layer enrichment is to be performed on an application layer stream. The at least one memory and the computer program code can be configured to, with the at least one processor, cause the apparatus at least to overwrite placeholder bytes inserted into the stream by a communicating application endpoint for the application layer enrichment.

According to certain embodiments, an apparatus can include at least one processor and at least one memory including computer program code. The at least one memory and the computer program code can be configured to, with the at least one processor, cause the apparatus at least to determine that application layer enrichment has been performed on an application layer stream. The at least one memory and the computer program code can also be configured to, with the at least one processor, cause the apparatus at least to read overwritten bytes, wherein the overwritten bytes were inserted by a middle box for the application layer enrichment into the stream transmitted by a communicating application endpoint.

A computer program product, according to certain embodiments, can encode instructions for performing a process. The process can include any of the above-described methods.

A non-transitory computer-readable can encode instructions, that, when executed in hardware, perform a process. The process can include any of the above-described methods.

### BRIEF DESCRIPTION OF THE DRAWINGS

For proper understanding of the invention, reference should be made to the accompanying drawings, wherein:

FIG. 1 illustrates application layer enrichment, according to certain embodiments.

FIG. 2 illustrates the enrichment of a request according to certain embodiments.

FIG. 3 illustrates a method according to certain embodiments.

FIG. 4 illustrates a system according to certain embodiments.

### DETAILED DESCRIPTION

Certain embodiments provide a method and apparatus for application layer enrichment over TCP in a middle box that does not require TCP connection termination or proxy and, at the same time, certain embodiments do not create invalid packets on the TCP level either. Certain embodiments involve the communicating application endpoints preparing the application layer header or data for enrichment by proactively inserting special placeholder bytes into the stream. The placeholder is overwritten by the enriching middle box without changing the total length of the packet, ensuring that the TCP sequence and ACK numbering remains consistent. Therefore, the connections can retain their valid end-to-end context without being split by a proxy functionality thus the solution is fully functional and does not introduce failure even in case of handovers.

Certain embodiments provide for implementing in-band application, such as HTTP, layer enrichment at a middle box without having to deploy a proxy and split the end-to-end TCP connection. Thus, certain embodiments provide an approach that is not a proxy, but still avoids creating invalid packets on the TCP level.

More particularly, certain embodiments provide a method and apparatus for application layer header or data enrichment in a middle box that does not require TCP connection termination or proxy and, at the same time, such embodiments may avoid creating invalid packets on the TCP level.

In certain embodiments, the application endpoints, such as a user equipment (UE) in uplink or the content server in downlink, prepare the application layer payload of the packets for enrichment by proactively inserting special placeholder bytes that are overwritten by the middle box without changing the length of the packet. This overwriting technique may ensure that the TCP sequence and ACK numbering remain consistent. Thus, the connections can retain their valid end-to-end context without being split by a proxy at the point of the enrichment. Additionally, the application endpoints do not need insight to the TCP layer, as the insertion of the placeholder bytes as well as the interpretation of the enriched information can be restricted to the application layer. Thus, the application endpoints can be fully implemented in the user space using standard network socket APIs without any kernel modification.

Certain embodiments may involve modification to the UE side as well. For example, a UE side client application or plug-in can insert the placeholder bytes. Moreover, certain embodiments may provide a generic enabler of in-band communication within the application layer and permit carrying in-band information between nodes, network elements or devices forwarding user plane traffic.

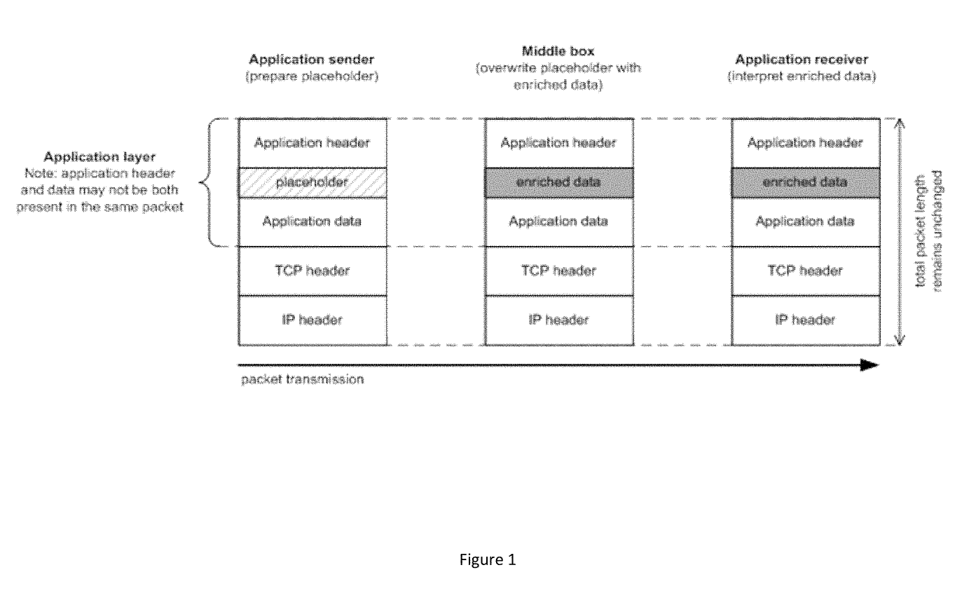

FIG. 1 illustrates application layer enrichment, according to certain embodiments. As shown in FIG. 1, the application sender can insert placeholder bytes in the application header and/or data. The application sender can be the entity transmitting data such as a web browser or content server.

The resulting TCP/IP packet can contain a space reserved for additional information. The middle box can recognize the placeholder and partly or fully overwrite the placeholder with any information that needs to be conveyed to the application receiver. As this step does not need to change the length of the packet, the TCP level sequence/ACK numbers can remain the same and valid. Accordingly, no split connection proxy may be needed. When the application receiver gets the packet, the application receiver can recognize and interpret the enriched information.

Certain embodiments apply to the enrichment of both downlink (DL) and uplink (UL) packets. The enrichment of UL packets can convey information to an external OTT server or content server, to an intermediate optimization gateway, or to an upstream proxy. The enrichment of the DL packets can convey information to the UE.

Certain embodiments can apply to any application layer protocol. One example is HTTP, which currently carries the majority of web traffic. HTTP is a bidirectional protocol. Thus, HTTP headers are transmitted both in the UL request and in the DL response, making HTTP header enrichment suitable for sending enriched information both to the content server in UL and to the UE in DL.

The SIP used to set up VoIP calls can also convey information to a SIP proxy or to either of the peers setting up the call. Likewise, the SDP that is used to describe real time media content can be used for enriching data in the DL, such as to convey additional information for the UE. Any other application layer protocol can similarly be subject to the enrichment method described herein.

The placeholder bytes can be inserted by the application sender or receiver into any part of the application layer data stream. In case of applications with headers, such as HTTP, a suitable implementation may be to insert one or more additional header fields filled with dummy bytes. The term “dummy” in this context can refer to bytes that can be later overwritten by the enriching middle box.

The placeholder may either be totally re-writable as containing only dummy bytes or the placeholder may contain read-only parts, which may be bytes that indicate the presence of the placeholder and may convey any additional context. The read-only parts may be in addition to a writable dummy part having bytes that can be overwritten by the middle box. The read only and/or writable part may specifically indicate what type of information is to be enriched in the writable part. The middle box needs to be aware of the structure and interpretation of the placeholder header field and the enclosing application layer protocol in order to recognize it and properly perform the enrichment within the writable part. The placeholder may be either human readable text, such as the fields in the HTTP header, a binary sequence, or a mixture of these.

Additionally or alternatively, placeholder bytes can also be inserted into the payload of the application layer protocol. In that case, the placeholder byte sequence may need to be unique within the packet payload, so that it does not collide with a byte sequence that was originally present in the packet header. This can be ensured in multiple ways, including but not limited to the following: by choosing a special byte sequence that is normally not valid within the application payload; specifying a dedicated location such as the beginning or end of the payload where the placeholder may be present; or enclosing a dynamic offset into the packet byte sequence indicating the location of the placeholder bytes, where the dynamic offset may be enriched into the TCP Option field, IP Option field, GTP extension header or any other protocol header that enables extensions. Multiple placeholders in a single packet are also possible.

The length of the placeholder may be selected based on the longest possible enriched value. This may be defined by the semantic, unit and range of the enriched data types, which may be subject to specification and shared with the application senders/receivers.

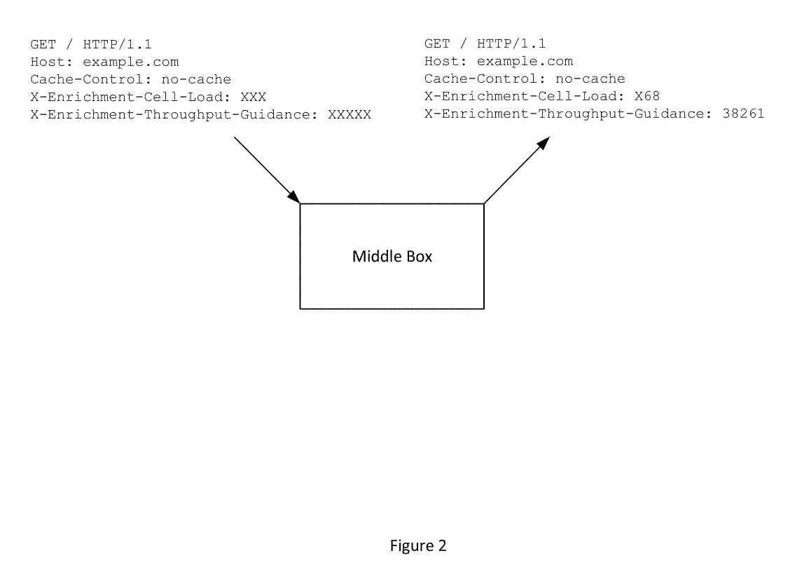

FIG. 2 illustrates the enrichment of a request according to certain embodiments. FIG. 2 more particularly illustrates an example HTTP request originated by the UE, prepared for enrichment by a middle box according to certain embodiments. The placeholder can be located in the HTTP header, encoded as an additional optional header field, for example, starting with “X-”. The dummy bytes can be implemented as “X” characters. Other implementations, such as zeros or special characters are also permitted.

The middle box can overwrite the placeholders with the corresponding value, resulting in the modified HTTP header shown on the right side. In case the enriched value is shorter than what is permitted by the placeholder, the unused bytes may remain unchanged. Alternatively, such bytes may also be overwritten. The overwritten but unused bytes may be overwritten with space, zero, or any other byte or character that indicates the boundaries of the useful value.

The placeholder bytes may be authenticated by the application endpoint to establish the identity of the source. The enriched information may also be authenticated, encrypted or both to verify the identity of the enriching middle box and/or the integrity of the enriched data. In case of authentication or encryption of the enriched data, the length of the placeholder may suffice for accommodating the authentication code and/or the encryption block. The authentication code may be, for example, 20 bytes of HMAC. The encryption block may be, for example, 16 bytes of an AES block.

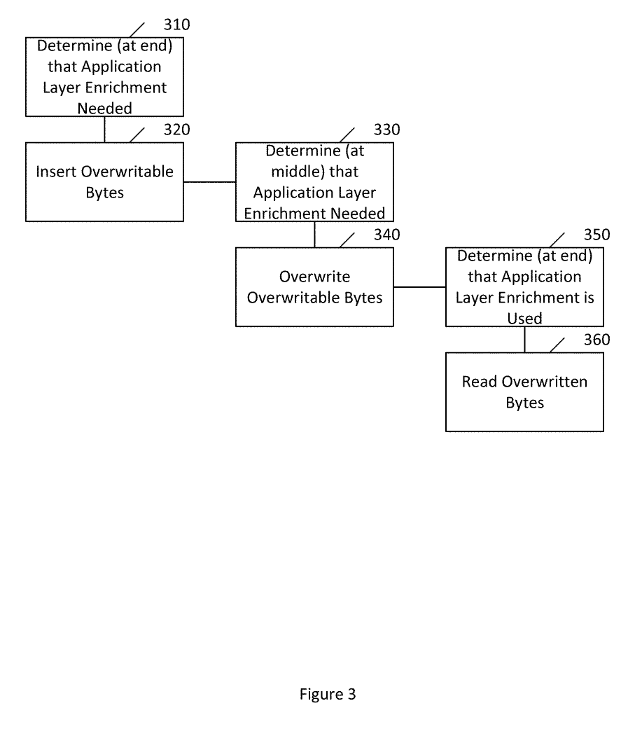

FIG. 3 illustrates a method according to certain embodiments. The method can include, at 310, determining that application layer enrichment is to be performed on an application layer stream. The method can also include, at 320, inserting, by a communicating application, placeholder bytes into the stream, wherein the placeholder bytes are configured to be overwritten for the application layer enrichment. The application layer stream can be a hypertext transfer protocol stream. Thus, the communicating application may be, for example a web browser. One of a pair of communication application endpoints for the application layer stream can perform the determining and inserting.

The method can also include, at 330, determining that application layer enrichment is to be performed on an application layer stream. The method can further include, at 340, overwriting placeholder bytes inserted into the stream by a communicating application endpoint for the application layer enrichment. The overwriting can be configured so that it does not change a total length of a corresponding packet. For example, unneeded bits can be overwritten with appropriate bits to indicate that they are not being used for enrichment and overwriting can be limited to the number of placeholder bytes. The overwriting can be performed at a middle box between a pair of communication endpoints. As noted above, the pair of communication endpoints can include a user equipment and a content server.

The overwriting the placeholder bytes can include overwriting at least some of all available placeholder bytes in the stream. Thus, in certain embodiments only some of the available placeholder bytes may be overwritten, while in other embodiments all of the available placeholder bytes may be overwritten. The overwriting the placeholder bytes can include at least one of choosing a special byte sequence that is normally not valid within an application payload; relying on a specified dedicated location where a placeholder is to be present; or enclosing a dynamic offset into a packet byte sequence indicating a location of the placeholder bytes.

The method can additionally include, at 350, determining that application layer enrichment has been performed on an application layer stream. The method can also include, at 360, reading overwritten bytes, wherein the overwritten bytes were inserted by a middle box for the application layer enrichment into the stream transmitted by a communicating application endpoint.

The placeholder bytes or the overwritten bytes can be variously implemented. For example, in certain embodiments the placeholder bytes may be in a header, in a payload, or in both a header and a payload.

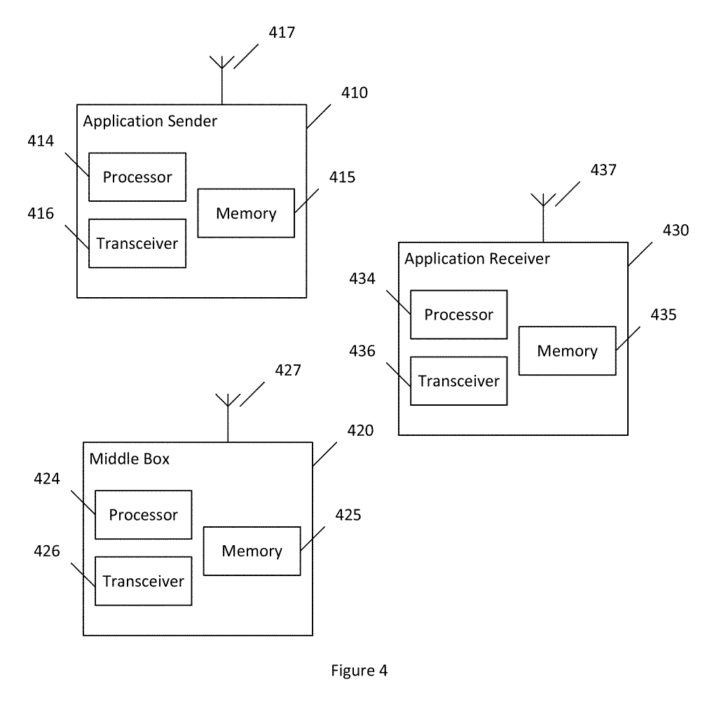

FIG. 4 illustrates a system according to certain embodiments of the invention. In one embodiment, a system may include multiple devices, such as, for example, at least one application sender 410, which may be a user equipment or content delivery network node, at least one middle box 420, which may be an eNB, RAGS, RNC, or other base station or access point, and at least one application receiver 430, which may be an adaptation gateway, OTT Server, UE, or other entity. The middle box 420 can be substituted by any middle box, which may be configured to lie between a UE and a content server.

Each of these devices may include at least one processor, respectively indicated as 414, 424, and 434. At least one memory can be provided in each device, and indicated as 415, 425, and 435, respectively. The memory may include computer program instructions or computer code contained therein. The processors 414, 424, and 434 and memories 415, 425, and 435, or a subset thereof, can be configured to provide means corresponding to the various blocks of FIG. 3.

As shown in FIG. 4, transceivers 416, 426, and 436 can be provided, and each device may also include an antenna, respectively illustrated as 417, 427, and 437. Other configurations of these devices, for example, may be provided. For example, application receiver 430 may be configured for wired communication, in addition to wireless communication, and in such a case antenna 437 can illustrate any form of communication hardware, without requiring a conventional antenna.

Transceivers 416, 426, and 436 can each, independently, be a transmitter, a receiver, or both a transmitter and a receiver, or a unit or device that is configured both for transmission and reception.

Processors 414, 424, and 434 can be embodied by any computational or data processing device, such as a central processing unit (CPU), application specific integrated circuit (ASIC), or comparable device. The processors can be implemented as a single controller, or a plurality of controllers or processors.

Memories 415, 425, and 435 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as application sender 410, middle box 420, and application receiver 430, to perform any of the processes described herein (see, for example, FIG. 3). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 4 illustrates a system including an application sender, middle box, and application receiver, embodiments of the invention may be applicable to other configurations, and configurations involving additional elements. For example, not shown, additional UEs may be present, and additional core network elements may be present, as illustrated in FIG. 2.

Although certain embodiments are described in terms of whole bytes being overwritten, in certain embodiments the bytes may be only partially overwritten. Other modifications are also permitted.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### Partial Glossary

ACK Acknowledgment

AES Advanced Encryption Standard

API Application Programming Interface

CA Carrier Aggregation

CDN Content Delivery Network

CSS Cascading Style Sheets

DL Downlink

DNS Domain Name Service

eNB Evolved Node B

GBR Guaranteed Bitrate

GPRS General Packet Radio Service

GTP GPRS Tunneling Protocol

GW Gateway

HMAC Hash Message Authentication Code

HSPA High Speed Packet Access

HTML Hypertext Markup Language

HTTP Hypertext Transfer Protocol

IP Internet Protocol

LTE Long Term Evolution

OTT Over The Top

PRB Physical Resource Block

RACS Radio Application Cloud Server

RNC Radio Network Controller

RRC Radio Resource Control

RRM Radio Resource Management

RSRP Reference Signal Received Power

RSRQ Reference Signal Received Quality

RTT Round Trip Time

SIP Session Initiation Protocol

SDP Session Description Protocol

TCP Transmission Control Protocol

TG Throughput Guidance

UE User Equipment

UL Uplink

WCDMA Wideband Code Division Multiple Access

VoIP Voice over IP

1.-32. (canceled)

33. A method in a communication application endpoint of an application layer stream, comprising:
determining that application layer enrichment is to be performed on an application layer stream; and
inserting, by a communicating application, placeholder bytes into the stream, wherein the placeholder bytes are configured to be overwritten for the application layer enrichment.

34. The method of claim 33, wherein the application layer stream comprises a hypertext transfer protocol stream.

35. A method in an apparatus between communication application endpoints of an application layer stream comprising:
determining that application layer enrichment is to be performed on an application layer stream;
detecting placeholder bytes inserted into the stream into the stream by a communicating application endpoint for the application layer enrichment; and
overwriting at least some of the placeholder bytes with information.

36. The method of claim 35, wherein the overwriting does not change a total length of a corresponding packet.

37. The method of claim 35, wherein the overwriting the placeholder bytes comprises at least one of choosing a special byte sequence that is normally not valid within an application payload; relying on a specified dedicated location where a placeholder is to be present; or enclosing a dynamic offset into a packet byte sequence indicating a location of the placeholder bytes.

38. A method, comprising:
determining that application layer enrichment has been performed on an application layer stream; and
reading overwritten bytes, wherein the overwritten bytes were inserted by a middle box for the application layer enrichment into the stream transmitted by a communicating application endpoint.

39. An apparatus, comprising:
at least one processor; and
at least one memory including computer program code,
wherein the at least one memory and the computer program code are configured to, with the at least one processor, cause the apparatus at least to
determine that application layer enrichment is to be performed on an application layer stream; and
insert, by a communicating application, placeholder bytes into the stream, wherein the placeholder bytes are configured to be overwritten for the application layer enrichment.

40. The apparatus of claim 39, wherein the application layer stream comprises a hypertext transfer protocol stream.

41. The apparatus of claim 39, wherein the apparatus comprises one of a pair of communication application endpoints for the application layer stream.

42. The apparatus of claim 39, wherein the placeholder bytes are in a header or payload.

43. An apparatus comprising:
at least one processor; and
at least one memory including computer program code,
wherein the at least one memory and the computer program code are configured to, with the at least one processor, cause the apparatus at least to
determine that application layer enrichment is to be performed on an application layer stream;
detect placeholder bytes inserted into the stream into the stream by a communicating application endpoint for the application layer enrichment; and
overwrite at least some of the placeholder bytes.

44. The apparatus of claim 43, wherein the at least one memory and the computer program code are configured to, with the at least one processor, cause the apparatus at least to overwrite the placeholder bytes without changing a total length of a corresponding packet.

45. The apparatus of claim 43, wherein the apparatus comprises a middle box between a pair of communication endpoints.

46. The apparatus of claim 43, wherein the at least one memory and the computer program code are configured to, with the at least one processor, cause the apparatus at least to overwrite the placeholder bytes using at least one of choosing a special byte sequence that is normally not valid within an application payload; relying on a specified dedicated location where a placeholder is to be present; or enclosing a dynamic offset into a packet byte sequence indicating a location of the placeholder bytes.

47. An apparatus, comprising:
at least one processor; and
at least one memory including computer program code,
wherein the at least one memory and the computer program code are configured to, with the at least one processor, cause the apparatus at least to
determine that application layer enrichment has been performed on an application layer stream; and
read overwritten bytes, wherein the overwritten bytes were inserted by a middle box for the application layer enrichment into the stream transmitted by a communicating application endpoint.

48. The apparatus of claim 47, wherein the placeholder bytes or the overwritten bytes are in a header or payload.

49. A non-transitory computer readable medium encoded with instructions that, when executed in hardware, perform a process, the process comprising the steps of
determining that application layer enrichment is to be performed on an application layer stream; and
inserting, by a communicating application, placeholder bytes into the stream, wherein the placeholder bytes are configured to be overwritten for the application layer enrichment.

50. A non-transitory computer readable medium encoded with instructions that, when executed in hardware, perform a process, the process comprising the steps of
determining that application layer enrichment is to be performed on an application layer stream;
detecting placeholder bytes inserted into the stream by a communicating application endpoint for the application layer enrichment; and
overwriting at least some of the placeholder bytes with information.

51. A non-transitory computer readable medium encoded with instructions that, when executed in hardware, perform a process, the process comprising the steps of
determining that application layer enrichment has been performed on an application layer stream; and
reading overwritten bytes, wherein the overwritten bytes were inserted by a middle box for the application layer enrichment into the stream transmitted by a communicating application endpoint.
